(19) United States
(12) Patent Application Publication
(10) Pub. No.: US 2019/0093562 A1
(43) Pub. Date: Mar. 28, 2019

(54) SCROLL FOR FUEL INJECTOR ASSEMBLIES IN GAS TURBINE ENGINES

(71) Applicant: Solar Turbines Incorporated, San Diego, CA (US)

(72) Inventors: Meagan Lau, San Diego, CA (US); James Wilfrid Blust, II, San Diego, CA (US); Leonel Arellano, Poway, CA (US); Georgina Jeannette McGee, San Diego, CA (US)

(73) Assignee: Solar Turbines Incorporated, San Diego, CA (US)

(21) Appl. No.: 15/718,751

(22) Filed: Sep. 28, 2017

(51) Int. Cl. F02C 7/22; F23R 3/28

(52) U.S. Cl. CPC F02C 7/222; F23R 3/28; F05D 2240/35; F05D 2260/96; F05D 2220/32

(57) ABSTRACT

A scroll for a fuel injector assembly of a gas turbine engine is disclosed. The scroll includes a cylindrical body that has an axial end face and an inner surface defining a bore. A passage spans circumferentially within the cylindrical body around the bore. Further, an inlet channel extends from the axial end face to the passage and is configured to facilitate a flow of a fuel to the passage. Moreover, outlets are formed in the cylindrical body to facilitate a release of the fuel from the passage. The cylindrical body includes a resonator integrally formed with the cylindrical body. The resonator includes a chamber, and a channel that fluidly couples the chamber to the inlet port.

### TECHNICAL FIELD

The present disclosure relates to gas turbine engines. More particularly, the present disclosure relates to a scroll for a fuel injector assembly having a resonator to dampen vibrations in a gas turbine engine.

### BACKGROUND

In combustion chambers of gas turbine engines, pressure or acoustic vibrations (or oscillations or pressure waves) may be generated during a combustion process. Commonly, such vibrations may range in frequencies from about twenty hertz to a few thousand hertz, and which may subject the combustion chamber to relatively severe mechanical loads. Such loads may interfere with an operation of the gas turbine engines and may decisively reduce a life of the combustion chamber, and of the components that are associated with the combustion chamber.

Acoustic vibrations (or oscillations) associated with the combustion process may cause vibrations in various parts or sub-systems of gas turbine engines. One such part and/or a sub-system may relate to an injector's fuel side or a fuel line of the gas turbines engines, and vibrations in such parts or sub-systems may cause an unsteady fuel supply to the combustion chamber, for example. To suppress or to attenuate vibrations in such parts or sub-systems, damping elements may need to be suitably positioned in the gas turbine engines. However, a complexity of gas turbine engine designs makes it difficult for such elements to be appropriately incorporated.

U.S. Pat. No. 9,383,097 relates to a staged fuel injector that includes, inter alia, a main fuel circuit for delivering fuel to a main fuel atomizer and a pilot fuel circuit for delivering fuel to a pilot fuel atomizer which is located radially inward of the main fuel atomizer. The main fuel atomizer includes a radially outer prefilmer and a radially inner fuel swirler. The prefilmer is formed using additive manufacturing.

### SUMMARY OF THE INVENTION

In one aspect, the disclosure is directed towards a scroll for a fuel injector assembly of a gas turbine engine. The scroll includes a cylindrical body that has an axial end face and an inner surface defining a bore. A passage spans circumferentially within the cylindrical body around the bore. Further, an inlet channel extends from the axial end face to the passage and is configured to facilitate a flow of a fuel to the passage. Moreover, outlets are formed in the cylindrical body to facilitate a release of the fuel from the passage. The cylindrical body includes a resonator integrally formed with the cylindrical body. The resonator includes a chamber, and a channel that fluidly couples the chamber to the inlet port.

In another aspect, the disclosure relates to a fuel injector assembly for a gas turbine engine. The fuel injector assembly includes a fuel line and a scroll. The fuel line is configured to facilitate a supply of fuel to a combustor of the gas turbine engine. The scroll has a cylindrical body including an axial end face and an inner surface defining a bore. A passage spans circumferentially within the cylindrical body around the bore, with an inlet channel extending from the axial end face to the passage. The inlet channel is fluidly coupled to the fuel line to facilitate a flow of the fuel from the fuel line to the passage. Further, a plurality of outlets is formed in the cylindrical body to facilitate a release of the fuel from the passage for a delivery of the fuel into the combustor. The cylindrical body includes a resonator integrally formed with the cylindrical body. The resonator includes a chamber, and a channel fluidly coupling the chamber to the inlet port.

In yet another aspect, the disclosure is directed to a gas turbine engine. The gas turbine engine includes a combustor, a fuel line configured to facilitate a supply of fuel to the combustor, and a scroll. The scroll includes a cylindrical body including an axial end face and an inner surface defining a bore. A passage spans circumferentially within the cylindrical body around the bore. An inlet channel extends from the axial end face to the passage. Further, the inlet channel is fluidly coupled to the fuel line to facilitate a flow of the fuel from the fuel line to the passage. A plurality of outlets is formed in the cylindrical body to facilitate a release of the fuel from the passage for a delivery of the fuel into the combustor. The cylindrical body includes a resonator integrally formed with the cylindrical body. The resonator includes a chamber, and a channel fluidly coupling the chamber to the inlet port.

### BRIEF DESCRIPTION OF THE DRAWINGS

FIG. 1 is a schematic view of an exemplary turbine engine, in accordance with an embodiment of the disclosure;

FIG. 2 is a cross-sectional view of the fuel injector assembly including a scroll and a pilot gas tube, in accordance with an embodiment of the disclosure:

FIG. 3 is a cross-sectional view of the fuel injector assembly including the scroll and a main gas tube, in accordance with an embodiment of the disclosure;

FIG. 4 is a sectional view of the scroll depicting a resonator, in accordance with an embodiment of the disclosure;

FIG. 5 is a sectional view of the scroll, depicting a passage of the scroll, in accordance with an embodiment of the disclosure;

FIG. 6 is a perspective view of the scroll depicting a swirler portion, in accordance with an embodiment of the disclosure;

FIGS. 7, 8, and 9, are embodiments of the resonator that are schematically depicted, in accordance with an embodiment of the disclosure;

FIGS. 10 and 11 are alternative views of an embodiment of the resonator that are depicted in cross-sectional views of the scroll, in accordance with an embodiment of the disclosure; and

FIGS. 12, 13, and 14, are yet other embodiments of the resonator that are depicted in cross-sectional views of the scroll, in accordance with an embodiment of the disclosure.

### DETAILED DESCRIPTION

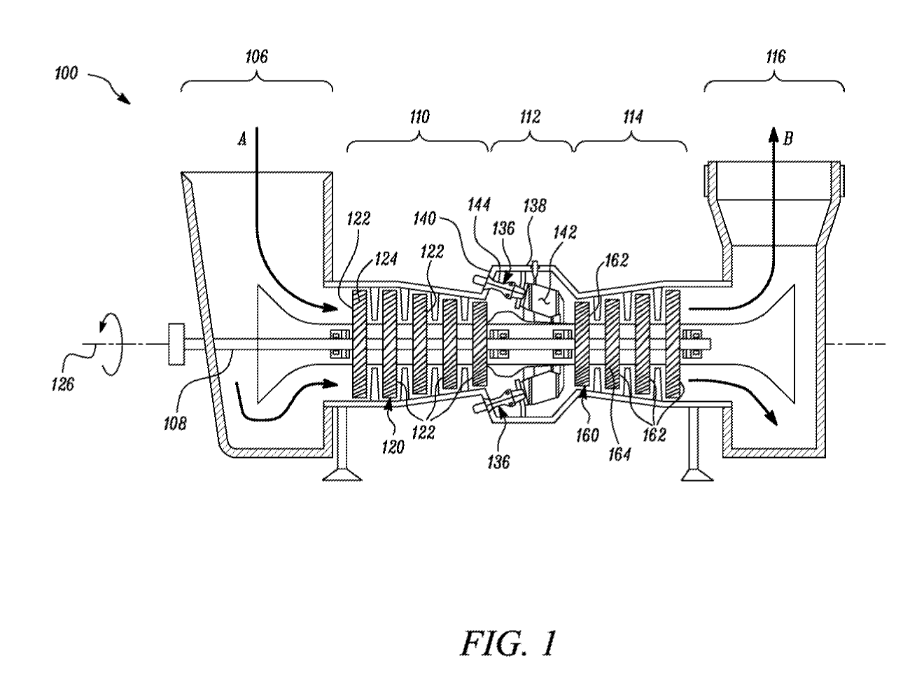

Referring to FIG. 1, a schematic illustration of an exemplary turbine engine 100 is provided. The turbine engine 100 may be a gas turbine engine. The turbine engine 100 may be associated with applications in a variety of machines. For example, the turbine engine 100 may be used to drive a compressor or may be used as a power source for a generator that produces electrical power. The turbine engine 100 may alternatively be applied as a prime mover of a machine, such as a mobile machine. Among other things, the turbine engine 100 includes an intake section 106, a shaft 108, a compressor section 110, a combustor section 112, a turbine section 114, and an exhaust section 116. In layout, the combustor section 112 may take a position in between the compressor section 110 and the turbine section 114, with the shaft 108 extending through each of the compressor section 110, the combustor section 112, and the turbine section 114.

The compressor section 110 includes a compressor disk assembly 120. The compressor disk assembly 120 includes multiple compressor rotor disks 122. Each compressor rotor disk 122 of the multiple compressor rotor disks 122 is circumferentially populated with a number of compressor blades 124 (only a single compressor blade 124 is annotated for clarity in FIG. 1). Each compressor rotor disk 122 is coupled and mounted to the shaft 108, such that a rotation of the shaft 108 translates into a rotation of the compressor rotor disks 122, in turn causing air to be drawn into the compressor section 110 through the intake section 106 (see direction. A, FIG. 1), and be pressurized and compressed by the compressor section 110. The shaft 108, along with the compressor rotor disks 122, defines an axis of rotation 126. As illustrated, the compressor disk assembly 120 is an axial flow rotor assembly (i.e. an assembly that facilitates air to flow along the axis of rotation 126, during operation). Further, given multiple compressor rotor disks 122 in the compressor disk assembly 120, the compressor section 110 may include and/or define multiple compressor stages for an inflowing air flow, with each stage increasing a degree, or an extent of a compression of air. In application, compressed air, generated by the compressor section 110, is directed towards the combustor section 112 for mixing with a fuel, such as a gaseous fuel, for example. Natural Gas.

The combustor section 112 is configured to receive and mix the compressed air with the fuel to form an air-fuel mixture, and combust said air-fuel mixture for production of motive power. In further detail, the combustor section 112 includes a fuel injector assembly 136 and a combustor 138, with the fuel for mixing with the compressed air being provided by the fuel injector assembly 136.

The combustor 138 includes a combustor wall 140 that houses a combustion chamber 142 of the turbine engine 100. In one implementation, as shown in FIG. 1, the combustor wall 140 may be annularly structured and may be arranged around the axis of rotation 126 such that the combustor wall 140 may be concentric to the axis of rotation 126. Further, the fuel injector assembly 136 includes a plurality of fuel injectors 144 that are coupled to the combustor wall 140, and given the annular construction of the combustor wall 140, an array of the plurality of fuel injectors 144 is also defined annularly around the shaft 108 (or around the axis of rotation 126). The plurality of fuel injectors 144 is in fluid communication with the combustion chamber 142 so that the combustion chamber 142 may receive fuel from the fuel injectors 144. In one example, the fuel injectors 144 are configured to inject a quantity of fuel into a stream of inflowing compressed air received from the compressor section 110, causing the fuel to mix with the inflowing compressed air and form the air-fuel mixture. The combustion chamber 142 may receive the air-fuel mixture for combustion, and combustion of the air-fuel mixture may generate hot gases that may expand and move at a relatively high speed into the turbine section 114.

The turbine section 114 is configured to receive the hot gases of combustion from the combustor section 112. As with the compressor section 110, the turbine section 114 includes a turbine disk assembly 160, and similar to the compressor disk assembly 120, the turbine disk assembly 160 includes multiple turbine rotor disks 162. Each turbine rotor disk 162 is circumferentially populated with a number of turbine blades 164 (only a single turbine blade 164 is annotated for clarity in FIG. 1). Further, each turbine rotor disk 162 is coupled and mounted to the shaft 108 (this is possible since a portion of the shaft 108 also extends into the turbine section 114, as has been already noted). Therefore, the turbine disk assembly 160 is rotatable about the same axis as the compressor disk assembly 120 (i.e. the axis of rotation 126 is a common axis of rotation to both the compressor disk assembly 120 and the turbine disk assembly 160). Effectively, the turbine disk assembly 160 is also an axial flow rotor assembly (i.e. an assembly that facilitates flow of the expanding hot gas along the axis of rotation 126, during operation). Given multiple turbine rotor disks 162, the turbine section 114 may include multiple turbine stages for the inflowing hot gas, with each stage being associated with an increase in a speed of an exit of the hot gases of combustion through the exhaust section 116 (see direction, B), and thus, an increase in a speed of rotation of the turbine disk assembly 160.

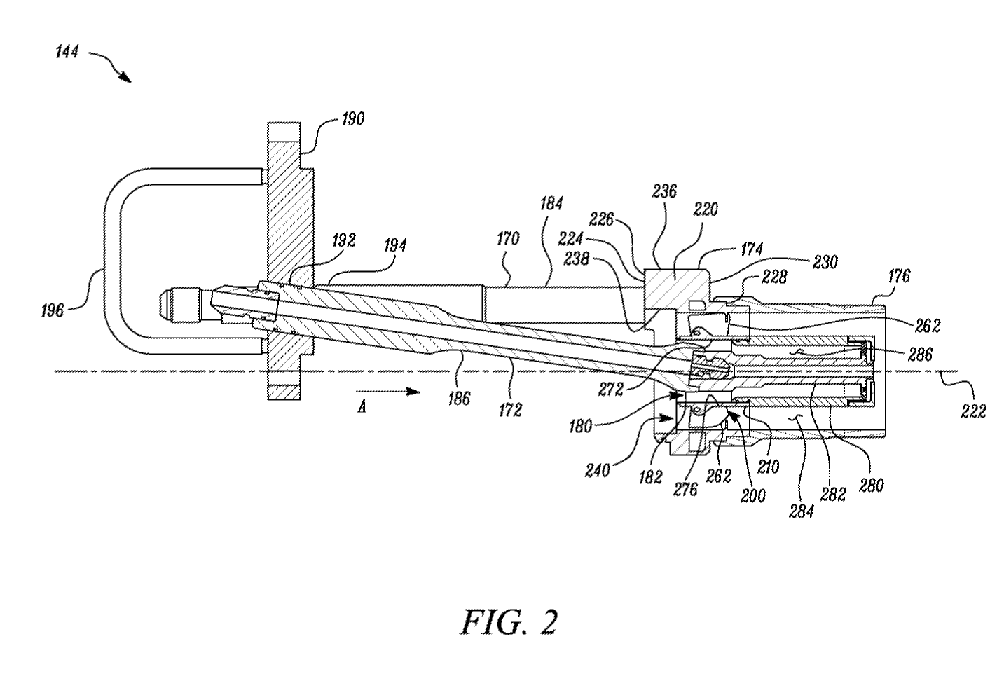

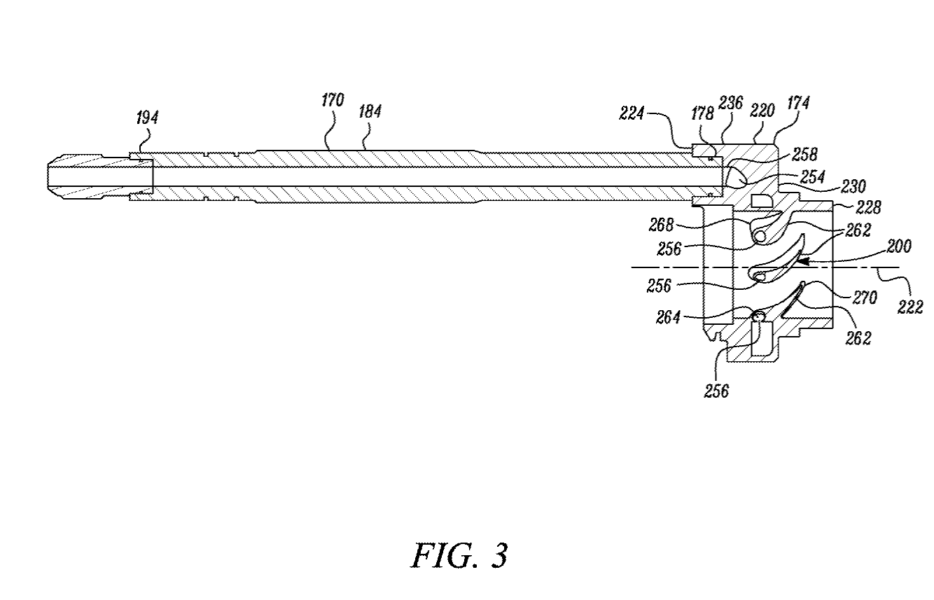

Referring to FIGS. 2 and 3, a detailed view of one fuel injector (also marked as fuel injector 144), out of the plurality of fuel injectors 144, is shown. Aspects and functioning described for the fuel injector 144 will be applicable to each fuel injector of the plurality of fuel injectors 144. As shown, the fuel injector 144 includes a variety of components that cooperate to inject the fuel into the combustion chamber 142 (i.e. into the stream of compressed air received from the compressor section 110, and thus to the combustion chamber 142). More particularly, the fuel injector 144 includes a main gas tube (MG tube 170), a pilot gas tube (PG tube 172), a scroll 174, and a barrel 176. The fuel injector 144 may include a variety of other tubes and components as well, but which are not shown to aid in clarity and understanding of the aspects that are relevant to the present disclosure.

The MG tube 170 facilitates a supply of a bulk of the fuel into the scroll 174, and thus into the combustor 138 (or combustion chamber 142) of the turbine engine 100. For example, the MG tube 170 may provide a fuel that is hydrocarbon with no air to the combustor 138 (or the combustion chamber 142) to inhibit or reduce the generation of oxides of nitrogen (NOx). The MG tube 170 may supply gaseous fuel from a gas manifold (not shown) to the scroll 174. For example, the MG tube 170 may include an end 178 (FIG. 3), and the MG tube 170 may be coupled to the scroll 174 through said end 178 by welding, brazing, or by use of industrial adhesives, for example.

The PG tube 172 may be coupled to and may be partially inserted into a pilot opening 180 of the scroll 174, and may be adapted to deliver a pressurized fuel into the combustion chamber 142 of the combustor 138. In one implementation, the PG tube 172 includes an end 182, and said end 182 may be welded or brazed to the scroll 174 at the pilot opening 180. Effectively, both the MG tube 170 and the PG tube 172 serve the purpose of supplying fuel into the combustion chamber 142 via two separate passages, satisfying one or more known functions associated with an operation of the combustor 138. Effectively, the MG tube 170 is a fuel line 184, or a main fuel line of the turbine engine 100, that facilitates a supply of the fuel to the combustor 138, while the PG tube 172 is a pilot fuel line 186 configured to inject a stream of pressurized fuel into the combustion chamber 142 of the combustor 138.

In some embodiments, the fuel injector 144 includes a flange 190 that supports an opposite end 192 (i.e. an end opposite to end 182) of the PG tube 172 and an opposite end 194 (i.e. an end opposite to end 178) of the MG tube 170. Said flange 190 may also support a variety of other tubes and structures (not discussed for clarity and conciseness) of the fuel injector 144. The flange 190 may facilitate a mounting of the fuel injector 144 to the turbine engine 100 (and, more specifically, to the combustor wall 140), and for this purpose, the flange 190 may include features such as one or more of fittings or connector assemblies (not shown). The flange 190 may be a cylindrical disk, although a variety of other shapes are possible, and may include handles 196 for handling the fuel injector 144.

The scroll 174 forms a portion of the fuel injector 144 that facilitates a mixing of the fuel with the compressed air received from the compressor section 110, and from which a mixture of the fuel and the compressed air (i.e. the air-fuel mixture) may be released and be delivered to the combustor 138. For mixing the air with fuel, in principle, the scroll 174 includes a swirler portion 200 that releases the fuel into a stream of the compressed air, during operation, such that an ensuing swirling action of the air-fuel mixture facilitates a distribution of the air-fuel mixture within the combustion chamber 142. Also, the scroll 174 includes a hollow cylindrical member 210. Aspects of the swirler portion 200 and the hollow cylindrical member 210 will be discussed later.

In further detail, the scroll 174 includes a cylindrical body 220 that defines a scroll axis 222. The cylindrical body 220 includes an axial end face 224 (i.e. at an axial end 226 of the cylindrical body 220). For the purpose of the ongoing discussion, the axial end face 224 may be referred to as a first end face 224, with the cylindrical body 220 including a second end face 228. The second end face 228 is axially and structurally opposed to the first end face 224 and includes a second end surface 230. The cylindrical body 220 further includes an outer surface 236 and an inner surface 238. The inner surface 238 defines a bore 240 of the scroll 174. It may be noted that an axis defined by the bore 240 may be same as the scroll axis 222. The bore 240 may be a through bore, extending from the first end face 224 all the way to the second end face 228. Further, the cylindrical body 220 includes a resonator 250, details of which will be discussed later in the application.

Referring to FIGS. 2, 3, and 5, furthermore, the cylindrical body 220 also defines a passage 254 that spans circumferentially within the cylindrical body 220, around the bore 240 (or around the scroll axis 222). In one example, the passage 254 is a gallery that receives fuel from the MG tube 170 for a transfer of the fuel to the swirler portion 200 of the scroll 174. To this end, a plurality of outlets 256 (FIG. 3) may be formed in the cylindrical body 220 to facilitate a release of the fuel from the passage 254 for a delivery of fuel into the combustor 138.

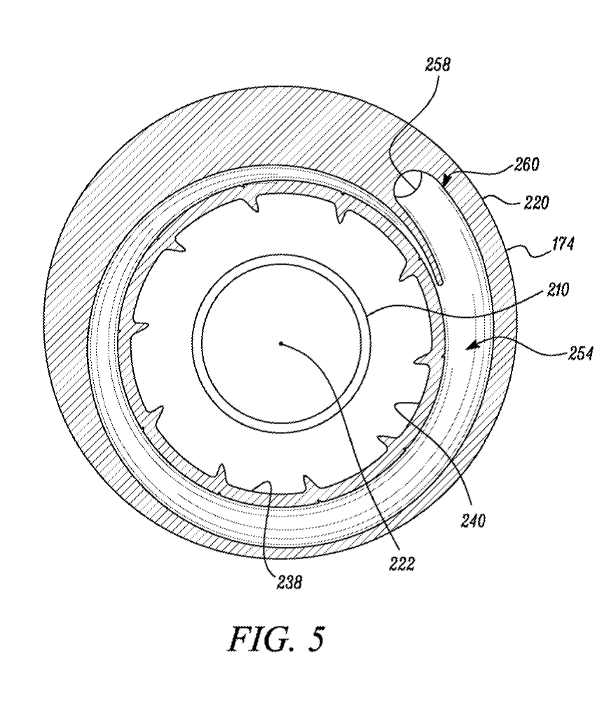

Moreover, the cylindrical body 220 defines an inlet channel 258 extending from the first end face 224 to the passage 254, and which is configured to facilitate a flow of the fuel from the first end face 224 to the passage 254. The inlet channel 258 is fluidly coupled to the MG tube 170. In an embodiment, the passage 254 includes a start portion 260 (FIG. 5) that is fluidly merged with the inlet channel 258 so that the passage 254 may receive fuel from the MG tube 170 through the inlet channel 258. The passage 254 may decrease in width from this start portion 260 up to a point where a one full circle of the passage 254 is defined, and moving further from this point, the passage 254 fluidly merges again into the start portion 260.

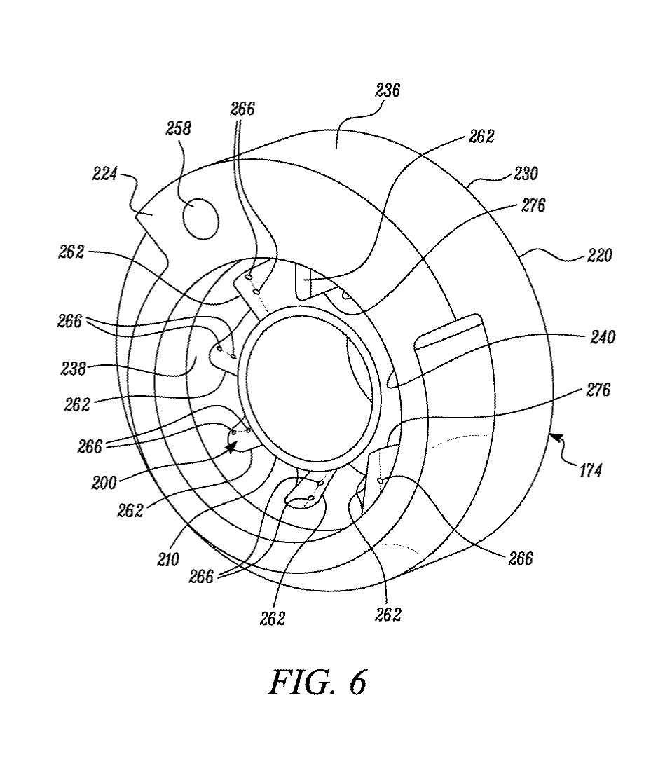

Referring to FIGS. 3 and 6, the swirler portion 200 may include multiple vanes 262 extending radially inwardly into the bore 240 from the inner surface 238 of the cylindrical body 220. Each vane 262 of the multiple vanes 262 includes a cavity 264. The cavity 264 within each vane 262 is fluidly coupled to the passage 254 by one or more of the outlets 256. In an embodiment, the outlets 256 may extend from the passage 254, pass through the inner surface 238 of the scroll 174, and enter into the cavity 264 of each vane 262. It may be noted that the decrease in width helps the passage 254 distribute fuel into the swirler portion 200, uniformly. This is because, the passage 254 reduces in cross-sectional area azimuthally around the scroll 174. This cross-sectional area is selected such that a cross-flow velocity of gas (i.e. fuel) at each of the outlets 256 is the same, so that a discharge coefficient of the fuel into each cavity 264 is the same, ensuring a circumferentially uniform distribution of fuel through the outlets 256 into the vanes 262.

Further, each vane 262 includes one or more openings 266 (FIG. 6) that facilitates a fuel, received from the passage 254 through the outlets 256, to be released from the cavity 264, and thus, out from the cylindrical body 220. Openings 266 may be relatively small holes located on the vanes 262 of the swirler portion 200. In the depicted embodiment, the openings 266 are positioned at a leading edge 268 (FIG. 3) of each vane 262. However, these openings 266 may be formed at a trailing edge 270 (FIG. 3) of each vane 262 as well. As shown, moreover, each vane 262 extends from the inner surface 238 into the bore 240 to define an end 276.

The hollow cylindrical member 210 is supported by the end 276 (FIGS. 2 and 6) of each vane 262. The hollow cylindrical member 210 defines the pilot opening 180, and is configured to accommodate and support the end 182 of the PG tube 172 (see FIG. 2). In so doing, the hollow cylindrical member 210 is configured to facilitate a passage for the concentrated, rich, and/or pressurized volume of fuel, through the PG tube 172, into the combustion chamber 142. In one example, the hollow cylindrical member 210 defines an axis that is same as the scroll axis 222 (i.e. the hollow cylindrical member 210 is co-axial with the scroll 174) defined by the cylindrical body 220.

The barrel 176 is coupled to the scroll 174 at the second end face 228 of the cylindrical body 220 of the scroll 174, and, for this purpose, the barrel 176 may engage or be press-fitted against a portion of the outer surface 236 of the cylindrical body 220. The barrel 176 houses a center body 280 with a center tube 282. The center tube 282 is positioned within the center body 280, with the center body 280 defining an annular space 286 with the center tube 282. The annular space 286 may be an extension of the pilot opening 180 within the center tube 282, along the scroll axis 222. The center tube 282 is configured to receive fuel from the PG tube 172, and is configured to inject said fuel into the combustor 138 (and thus into the combustion chamber 142) as a first stream. Further, the barrel 176 is positioned around the center body 280 to form an annular mixing duct 284 there between. The annular mixing duct 284 facilitates a mixing of fuel received through the openings 266 in the vanes 262 with the compressed air (flowing past the vanes 262 from the compressor section 110), to produce the air-fuel mixture (such as a lean premixed fuel). The annular mixing duct 284 is configured to deliver this lean premixed fuel into the combustor 138 (and thus into the combustion chamber 142) as a second stream, without mixing with the first stream. Notably, the pilot opening 180 provides a fuel-air mixture often richer than provided by the annular mixing duct 284 to facilitate flame stabilization within the combustor 138.

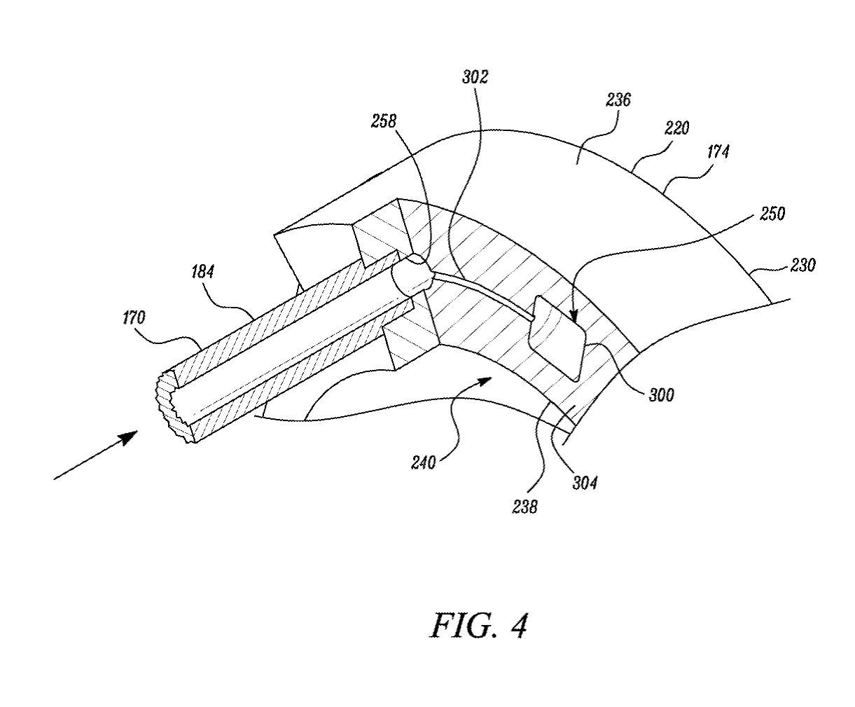

Referring to FIG. 4, the resonator 250 is configured to dissipate an energy of a pressure wave of combustion within the combustion chamber 142. The resonator 250 is integrally formed within the cylindrical body 220 of the scroll 174. In an embodiment, the resonator 250 is a Helmholtz resonator, and includes a chamber 300 and a channel 302, as shown.

The channel 302 is fluidly coupled between the chamber 300 and the inlet channel 258, thus fluidly coupling the chamber 300 to the inlet channel 258. In an embodiment, the channel 302 of the resonator 250 is defined along a plane 304 (plane 304 is marked as a surface defined by a cross-section of the cylindrical body 220 of the scroll 174). In an embodiment, the plane 304 is perpendicular to the scroll axis 222. Moreover, the channel 302 may include a cylindrical cross-sectional profile, although it is possible for the channel 302 to include a rectangular cross-sectional profile as well. In other examples, the channel 302 may possess an elliptical cross-sectional profile or an irregular cross-sectional profile. In an embodiment, the channel 302 is defined along a curvature of the cylindrical body 220, and thus, the channel 302 may be curved in profile as well, along an expanse of the plane 304 that is perpendicular to the scroll axis 222.

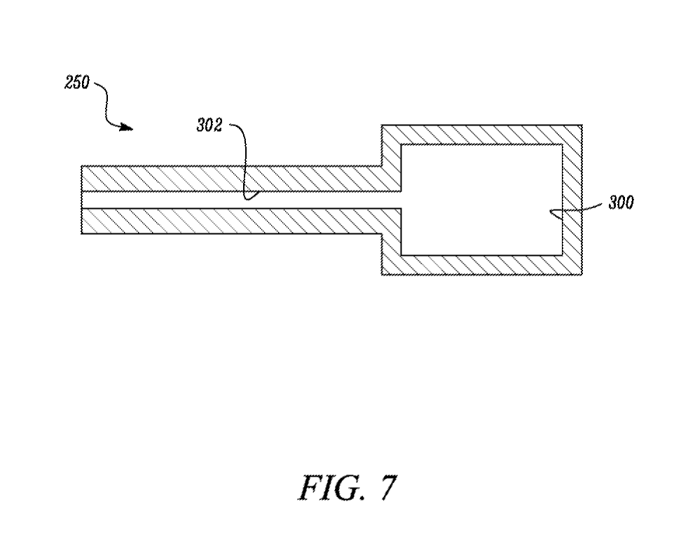

The chamber 300 may be configured to admit a volume of a fluid through the channel 302, and facilitate a dissipation of energy of a pressure wave generated from combustion (discussed in detail later). In one scenario, the chamber 300 includes a cylindrical shape (also see FIG. 7), although it is possible that the chamber 300 may include a variety of other shapes, such as a cuboidal shape, or a shape having an oblong cross-section, or a shape having an irregular cross-section.

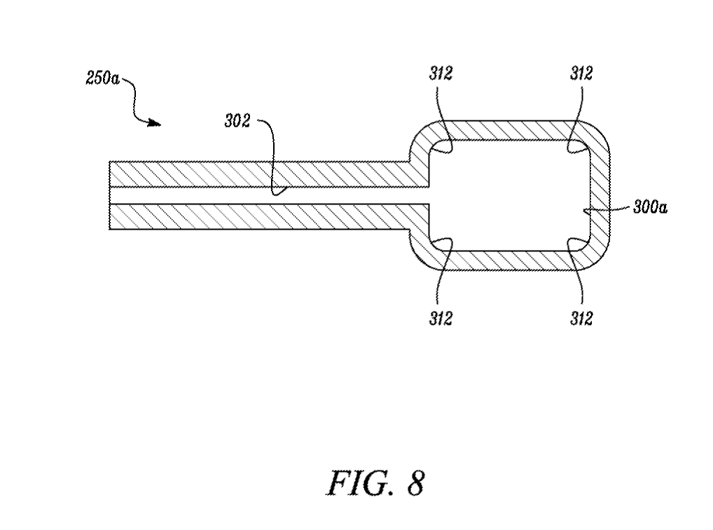

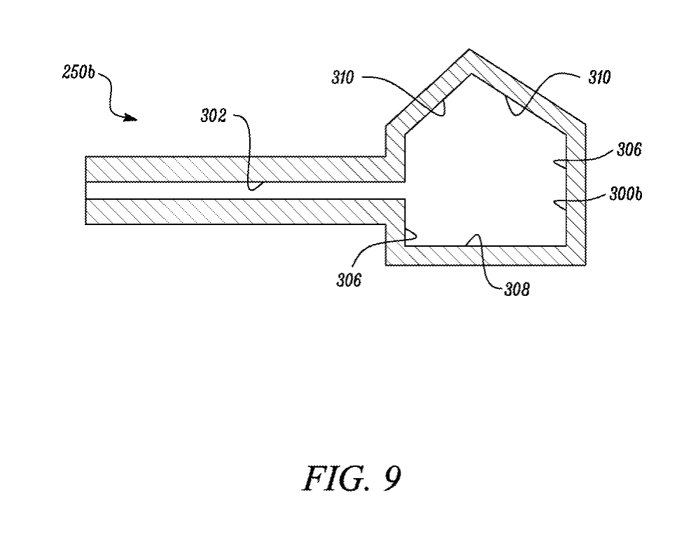

Referring to FIGS. 7, 8, and 9, different schemes of resonator designs, as different resonator embodiments, have been illustrated and discussed. The embodiment of FIG. 7 generally represents the same scheme (i.e. a resonator with a cylindrical/rectangular profile) as has been described in FIG. 4. In the embodiment of FIG. 8, a resonator 250a has been shown. The resonator 250a may include a chamber 300a with a rectangular profile, but with rounded (filleted) edges 312. In the embodiment of FIG. 9, a resonator 250b has been shown. The resonator 250b may include a chamber 300b that may include a pentagonal structure (i.e. a structure that in one cross-section defines five edges, as shown). More particularly, two alternate edges 306 of the chamber 300b may make right angles with a connecting edge 308 (i.e. an edge that connects the alternate edges 306), while the remaining two edges 310 of the chamber 300b may respectively make obtuse angles with the alternate edges 306 and also be tilted to each other, as shown.

In an embodiment, the scroll 174 may be made of any material suitable for the application. For example, the scroll 174 may be made of a high strength, nickel based, corrosion resistant alloy, such as, for example, Hastelloy®. Further, the swirler portion 200 may be manufactured by the same materials, for example. In an embodiment, the scroll 174 and the swirler portion 200 are integrally formed as the cylindrical body 220. In an embodiment, the scroll 174 (i.e. the cylindrical body 220 of the scroll 174), or both the scroll 174 and the swirler portion 200, are formed by an additive manufacturing process. In an embodiment, additive manufacturing techniques include, for example, direct metal laser sintering (DMLS—a form of direct metal laser fusion (DMLF)) with nickel base super-alloys, low density titanium, and aluminum alloys. Other technique of additive manufacturing includes electron beam melting (EBM) with titanium, titanium aluminide, and nickel base super-alloy materials.

In one embodiment, the chamber 300 is a cylindrical chamber, and may include a volume of 0.306 cubic inch (in³). For example, a height of the chamber 300 may be 0.791 ins, while the diameter of the chamber 300 may be 0.701. Notably, the channel 302, in some implementations, may include a diameter of 0.070 inch (in), while a length of the channel 302 may be 0.809 in.

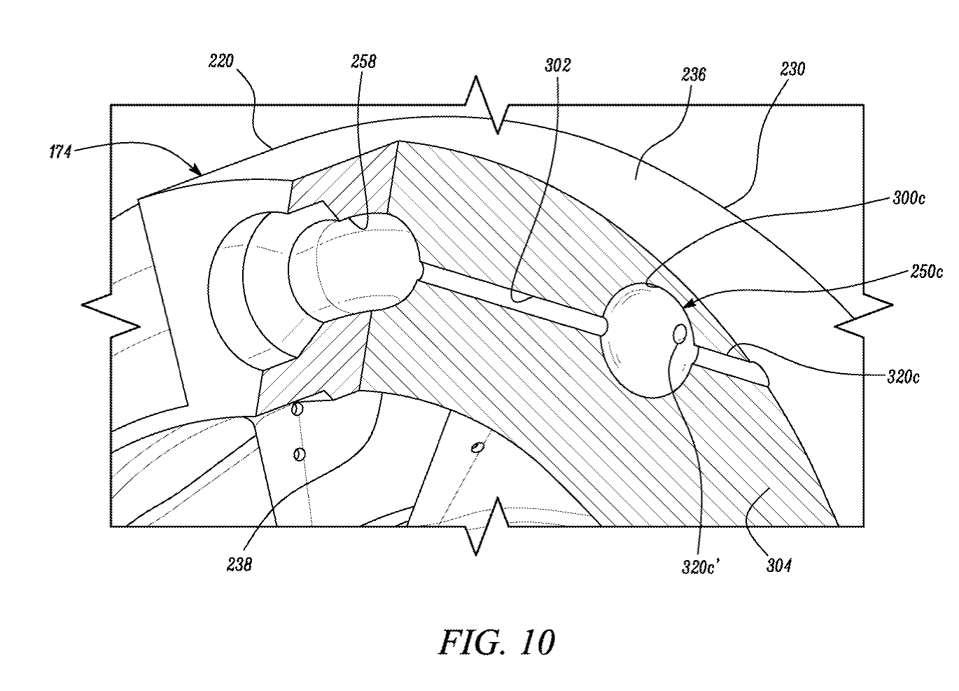

Referring to FIGS. 10, 11, 12, 13, and 14, additional embodiments of the resonator 250, as resonators 250c, 250d, 250d′, 250e, 250e′, and 250f, are depicted. The resonators 250c, 250d, 250d′, 250e, 250e′, and 250f, depicted in FIGS. 10, 11, 12, and 13, vary from the resonators 250, 250a, and 250b, described in the earlier figures. In detail, the resonators 250c, 250d, 250d′, 250e, 250e′, and 250f, include chambers that are spherical in shape and design. More specifically, the resonators 250c, 250d, 250d′, 250e, 250e′, and 250f, respectively include chambers 300c, 300d, 300d′, 300e, 300e′, and 300f. A channel (i.e. the channel 302) for the resonators 250c, 250d, 250d′, 250e, 250e′, and 250f, may be same as has been discussed for the resonators 250, 250a, 250b. The resonators 250c, 250d, 250d′, 250e, 250e′, and 250f, may be manufactured from an additive manufacturing process as well, as has been discussed above.

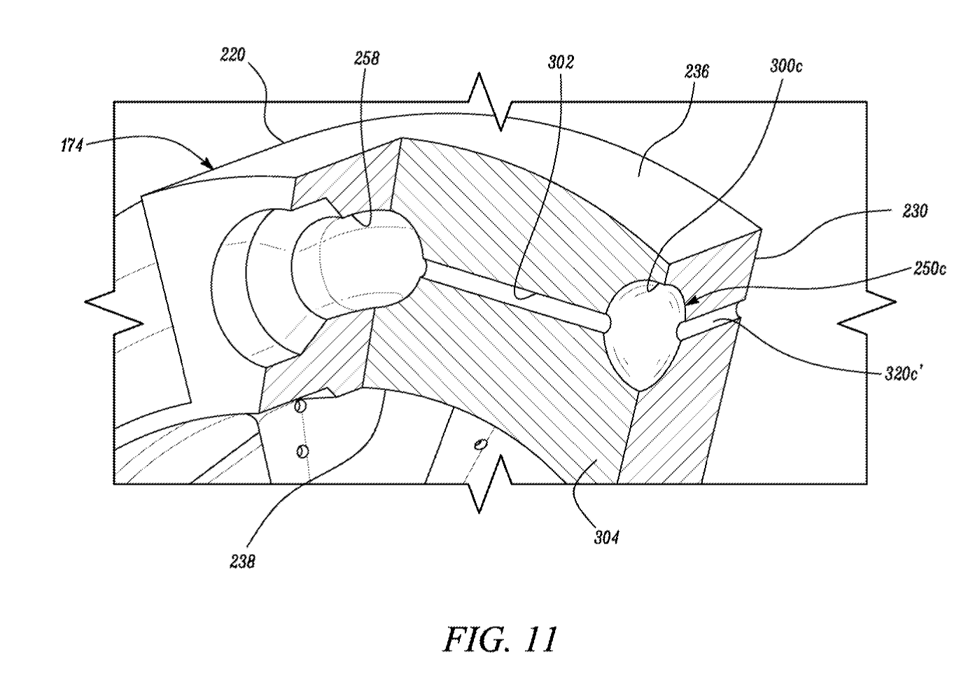

Referring to FIG. 10, the resonator 250c may include a chamber 300c and the channel 302. The chamber 300c may include egress passages 320c, 320c′ (also see FIG. 11) that may be used to remove a powder used in an additive manufacturing process. As shown, the egress passage 320c starts from the chamber 300c at a point substantially diametrically opposed to a point where the channel 302 meets the chamber 300c. Moreover, the egress passage 320c is in line with the channel 302 that allows a manual access to the channel 302. Furthermore, the egress passage 320c may extend from the chamber 300c all the way to the outer surface 236. On the other hand, the egress passage 320c′ (FIG. 11) extends from the chamber 300c all the way to the second end surface 230 of the cylindrical body 220. In an embodiment, the channel 302, the egress passage 320c, and egress passage 320c′, may be coplanar. In yet another embodiment, the channel 302 may be perpendicular to the egress passage 320c′, and the egress passage 320c′ may be perpendicular to the egress passage 320c.

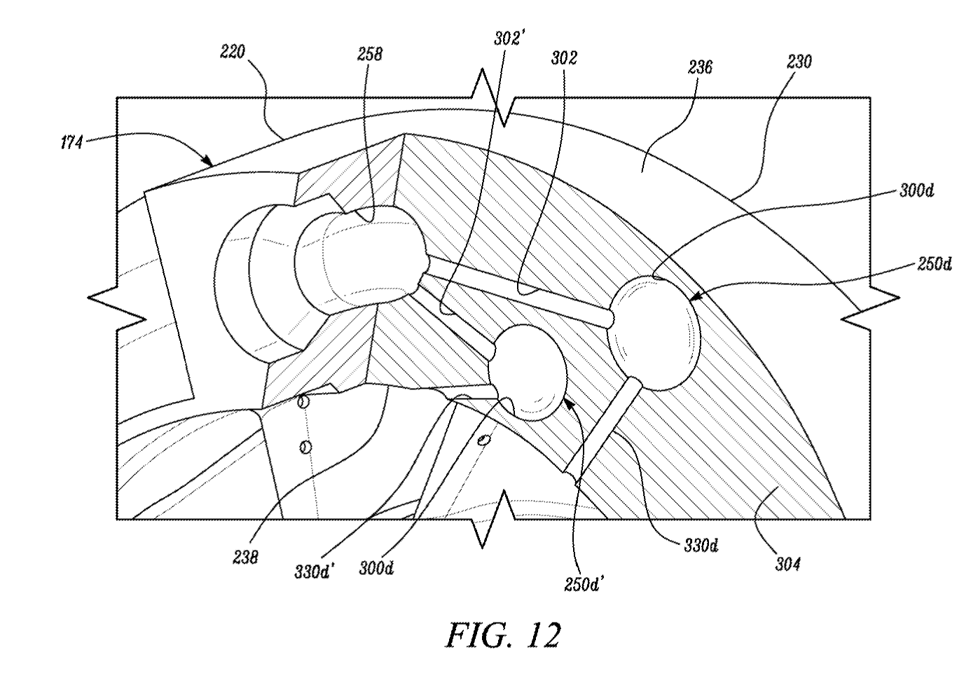

FIG. 12 shows the cylindrical body 220 having two resonators 250d, 250d′ in parallel. To this end, the resonator 250d and resonator 250d′ may respectively be first resonator 250d and second resonator 250d′, arranged in parallel. Each of the resonators 250d, 250d′ target a different frequency of oscillation/vibration, but remain independent of each other. As above, resonators 250d, 250d′ may respectively have chambers 300d, 300d′. While the chamber 300d may be fluidly coupled to the inlet channel 258 via the channel 302 (or referred to as a first channel 302), the chamber 300d′ may be fluidly coupled to the inlet channel 258 via a separate, second channel 302′, as shown. In effect, the second channel 302′ may be fluidly coupled to the inlet channel 258 independent of a coupling of the first channel 302 to the inlet channel 258. Further, chambers 300d, 300d′ respectively include egress passages 330d, 330d′. Egress passage 330d extends from the chamber 300d to the inner surface 238. Similarly, egress passage 330d′ extends from the chamber 300d′ to the inner surface 238, as well. The egress passages 330d, 330d′ may be used to remove a powder used in an additive manufacturing process, as noted in the above embodiment.

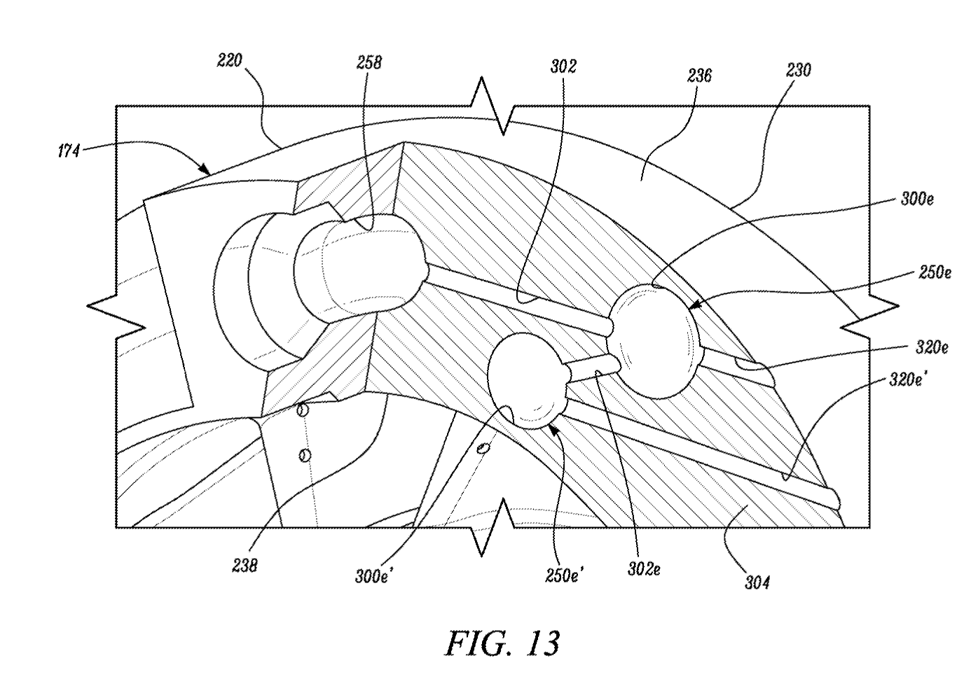

FIG. 13 shows the cylindrical body 220 having two resonators 250e, 250e′ in series. To this end, the resonator 250e and resonator 250e′ may respectively be first resonator 250e and second resonator 250e′, arranged in series. As with resonators 250d, 250d′, resonators 250e, 250e′ may also target a different frequency of oscillation/vibration. The resonators 250e, 250e′ are fabricated in series. As the above noted embodiments, the resonator 250e and resonator 250e′ respectively include chambers 300e, 300e′. While the chamber 300e is fluidly coupled to the inlet channel 258 via channel 302, the chamber 300e′ is coupled to the inlet channel 258 via the chamber 300e. To this end, the resonators 250e, 250e′ are connected in series by having a third channel 302e fluidly extended between the chamber 300e (also referred to as a first chamber 300e) and chamber 300e′ (also referred to as second chamber 300e′). Further, the chambers 300e, 300e′ respectively include egress passages 320e, 320e′ for powder removal during additive manufacturing. In the embodiment described in FIG. 13, the egress passages 320e, 320e′ respectively extend from the chambers 300e, 300e′ all the way to the outer surface 236 of the cylindrical body 220. Although the embodiments depicted and discussed corresponding FIGS. 12 and 13 include a twin resonator arrangement, a plurality of resonators, either in parallel or in series, each targeting a different frequency, may be used.

In one embodiment, the egress passages 320c, 320c′, 330d, 330d′, 320e, and 320e′, discussed above may be plugged using a plug (not shown) once an associated additive manufacturing/3-dimensional (3D) printing process is complete. For example, a plug, applied to any of the egress passages 320c, 320c′, 330d, 330d′, 320e, and 320e′, may be shape compliant with said corresponding egress passages 320c, 320c′. 330d, 330d′. 320e, and 320e′. Methods, such as brazing, may be applied to positively couple such a plug within corresponding egress passages 320c, 320c′, 330d, 330d′, 320e, and 320e′. Further, each plug may be sized to fill the corresponding egress passages 320c, 320c′, 330d, 330d′, 320e, and 320e′ fully, so as to leave the respective chambers 300c, 300d, 300d′, 300e, and 300e′, the intended size.

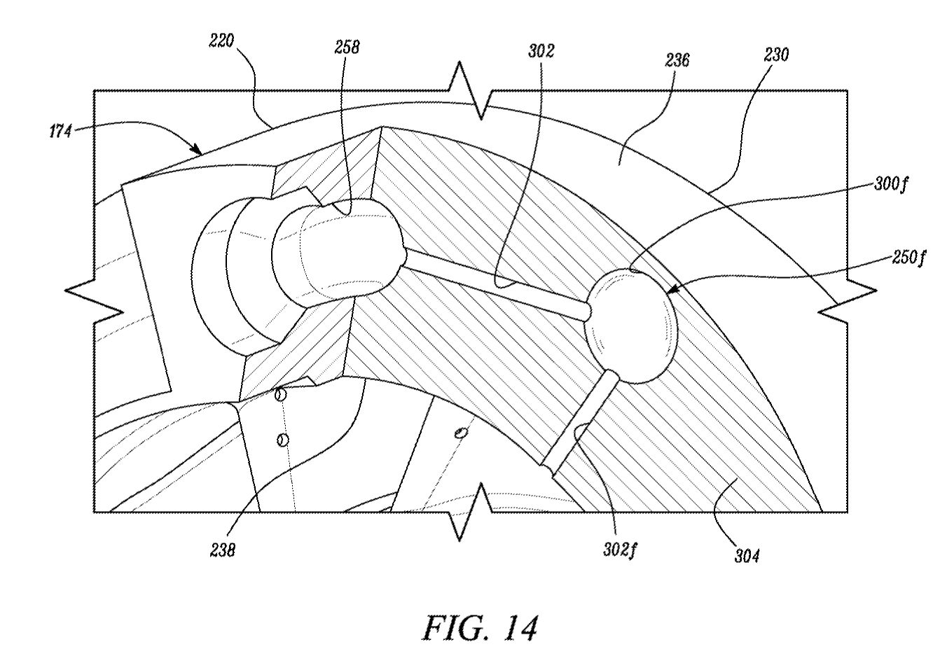

FIG. 14 shows one resonator 250f. The resonator 250f includes a chamber 300f, the channel 302, and an auxiliary channel 302f. Like in above discussed embodiments, the channel 302 is fluidly coupled between the chamber 3001 and the inlet channel 258. The auxiliary channel 302f, however, fluidly extends from the chamber 300f to the inner surface 238. Furthermore, the auxiliary channel 302f is not plugged. In one embodiment, both the channel 302 and the auxiliary channel 302f may have the same diameter or a cross-sectional area.

### INDUSTRIAL APPLICABILITY

During operation of the turbine engine 100, air may be drawn into the turbine engine 100 and be compressed via the compressor section 110. Compressed air generated by the compressor section 110 may then be directed into the combustor section 112 through the fuel injector 144. It may be noted, that the fuel in PG tube 172 is typical gaseous hydrocarbons with no air. Within a passage between the center body 280 and the center tube 282, compressed air enters through the pilot opening 180. Some portion of that air enters the passage within center tube 282 along the scroll axis 222 via holes (not shown in FIG. 2) to mix with the fuel from the PG tube 172. A mixture thus formed may be concentrated, rich, and/or be pressurized.

In further detail, as the compressed air flows through the swirler portion 200 and the barrel 176, towards the combustion chamber 142, a typical profile of the plurality of vanes 262 facilitates the generation of the swirling action of the air passing across each vane 262. This swirling action ensures a proper mix of the fuel, injected by each vane 262, with the compressed air received from the compressor section 110. Notably, this mixing forms the air-fuel mixture. The fuel/air mixture may then proceed to the combustion chamber 142. Notably, the swirling action may also help in a distribution of the air-fuel mixture in the combustion chamber 142, assisting in combustion.

As the air-fuel mixture enters the combustor 138 (i.e. the combustion chamber 142), the air-fuel mixture may be ignited and combusted. A release of energy accompanying the combustion process may heat the combustion chamber 142 and the gases within the combustion chamber 142. As a result, hot gases within the combustion chamber 142 may be formed, and which may start to expand within the combustion chamber 142. The hot expanding gases may then flow into turbine section 114, where the energy of the combustion gases may be converted to rotational energy of the turbine disk assembly 160 (i.e. the turbine rotor disks 162) and the shaft 108. Since the shaft 108 is also coupled to the compressor disk assembly 120, a rotation of the shaft 108 causes a rotation of the compressor disk assembly 120, in turn powering the compressor section 110 of the turbine engine 100. Thereafter, the hot expanding gases pass through the turbine disk assembly 160 and are expelled out of the turbine engine 100 as exhaust.

The combustion process may also give rise to instabilities that cause pressure waves within combustion chamber 142. These pressure waves may include regions of compressions (regions of high air pressure) and rarefactions (regions of low air pressure). The pressure waves may propagate in all directions within combustion chamber 142, out of the combustion chamber 142, and components associated with the combustion chamber 142 (or the combustor 138). Pressure waves may also impinge on the resonator 250, 250a. 250b formed within the fuel injector 144. For ease in understanding, further discussion will include references to only the resonator 250. Such discussions will be applicable for the resonators 250a, 250b, as well.

If pressure waves are left unchecked, vibrations may be generated that may continue until a source of energy causing the vibrations is removed, or until an operation of the turbine engine 100 is altered to a different operational range, for example. However, changing system variables and causing a change in operational characteristics of the turbine engine 100 may be undesirable in most situations. One or more aspects of the present disclosure are related to suppressing or attenuating vibrations in one or more parts or sub-systems of the turbine engine 100. Such parts or sub-systems relate to the injector's (i.e. the fuel injector 144's) fuel side or fuel lines (MG tube 170 and PG tube 172) of the turbine engine 100.

When pressure waves are generated, pressure waves impinge on the inlet channel 258 and thus the resonator 250. As a result, a small quantity of a fluid (which in this case is fuel) may be forced into chamber 300 since the chamber 300 is in fluid communication with the inlet channel 258 through the channel 302, thereby increasing a pressure inside the chamber 300. When a rarefied region (regions of low air pressure) of the pressure waves impinges on the inlet channel 258, a driving force that pushed the fluid (i.e. fuel) into the chamber 300 may reduce, and a pressurized fluid from inside the chamber 300 may flow back into the inlet channel 258 through the channel 302. Due to a momentum of the fluid flowing out of the chamber 300 (and thus the channel 302), this fluid outflow may continue past a point of pressure equilibrium and cause a lower pressure within chamber 300. This pressure imbalance may draw air back into the chamber 300, and the process may be repeated. Frictional and other losses during such repeated inflow and outflow of fluid (i.e. fuel) relative to the channel 302 and the chamber 300 may gradually dissipate the energy of the pressure waves, thereby damping the pressure waves.

Embodiments of the resonators 250c, 250d, 250d′, 250e, and 250e′, as described in FIGS. 10, 11, 12, and 13, work in a similar fashion as has been noted for the resonators 250, 250a, and 250b, above. It may be well understood that the embodiments in FIGS. 12 and 13 (i.e. resonators 250d and 250e) are configured to target two different/separate frequencies of oscillations/vibrations.

Referring to FIG. 14, the resonator 250f damps oscillations via a different means than described for the resonators 250, 250a, 250b, 250c, 250d, 250d′, 250e, and 250e′. More particularly, since the chamber 300f of the resonator 250f is fluidly coupled to both the bore 240 (by extending all the way to the inner surface 238) and the inlet channel 258, the resonator 250f facilitates absorption/dissipation of noise/acoustic vibrations and oscillations from both the annular mixing duct 284 and the passage 254. In further detail, resonator 250f may act as a low pass filter to filter out any frequencies higher than a threshold or a cut off frequency. In an example, resonator 250f may act as a reactive filter that suppresses a transmission of dynamic pressure perturbations through changes in impedance at their intersection with the fuel passages or channels (such as inlet channel 258). Ensuing changes in impedance may give rise to reflected waves that reduce an amount acoustic energy carried forward. In one example, resonator 250f may help dissipate frequencies above 200 Hz.

In one scenario, fuels, such as gaseous fuels, incoming from the MG tube 170, may produce a residue of hydrocarbon condensates. In such a case, the auxiliary channel 302f may allow fuel to be vented out into the fuel injector 144, allowing fuel to spill back into a path of fuel flow (i.e. into the annular mixing duct 284), rather than venting out into the combustor 138, or dwelling within the chamber 300f and possibly undergoing undesirable chemical reactions.

The disclosed fuel injector 144 with the resonator 250 (which is a Helmholtz resonator) may be applicable to any turbine engine where reduced vibrations within the turbine engine are desired. Although particularly useful for low NOx-emitting engines, the disclosed fuel injector 144 may be applicable to any turbine engine regardless of the emission output of the turbine engine. The disclosed fuel injector 144 with the resonator 250 may reduce vibrations by acoustically attenuating naturally-occurring pressure fluctuations within the inlet channel 258 of the fuel injector 144, thus being able to effectively suppress or to attenuate vibrations in such parts or sub-systems of the turbine engine 100.

Further, by use of an additive manufacturing process, manufacturing complex geometries and surfaces of the resonator (i.e. of both the channel 302 and the chamber 300), is possible. Moreover, by additive manufacturing techniques, it is also possible to more easily integrate a structure of the resonators 250 into the cylindrical body 220 of the scroll 174 as compared to conventional manufacturing practice. Furthermore, having identified a suitable location of the resonator 250, such as within the scroll 174, and with the channel 302 fluidly extending into the inlet channel 258, additive manufacturing imparts more freedom to locate resonator chambers and resonator channels during a manufacturing, such as has been in this case (i.e. in the present disclosure). A suitable positioning of the resonator 250 results in a more effectively dampening of vibrations and oscillations.

Further, by use of an additive manufacturing process, it becomes easier for the scroll 174 and the swirler portion 200 to be integrally formed, as well. An integral scroll 174 and swirler portion 200 reduces assembly/disassembly time, and avoids effort typically required for mounting several components in an assembly, such as in an assembly of conventional scroll assemblies. For example, such as an end cap that may be generally assembled to a scroll from an end face (such as second end face 228) of the scroll 174. Moreover, integral structures attained through additive manufacturing techniques also reduce a bulk and complexity associated with the related assembly.

It will be apparent to those skilled in the art that various modifications and variations can be made to the system of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalent.

What is claimed is:

1. A scroll for a fuel injector assembly of a gas turbine engine, the scroll comprising:
a cylindrical body including an axial end face and an inner surface defining a bore, a passage spanning circumferentially within the cylindrical body around the bore, an inlet channel extending from the axial end face to the passage and configured to facilitate a flow of a fuel to the passage, a plurality of outlets formed in the cylindrical body to facilitate a release of the fuel from the passage, the cylindrical body including:
a resonator integrally formed with the cylindrical body, the resonator including a chamber, and a channel fluidly coupling the chamber to the inlet channel.

2. The scroll of claim 1 further comprising a plurality of vanes extending radially inwardly into the bore from the inner surface of the cylindrical body, each vane including a cavity fluidly coupled to the passage by one or more of the plurality of outlets, wherein each vane includes one or more openings to release the fuel from the cavity.

3. The scroll of claim 1, wherein the resonator is a first resonator and the channel is a first channel, the scroll including a second resonator with a second channel, the second channel being fluidly coupled to the inlet channel independent of a coupling of the first channel to the inlet channel.

4. The scroll of claim 1, wherein the resonator is a first resonator and the chamber is a first chamber, the scroll including a second resonator with a second chamber, the first chamber being fluidly coupled to the second chamber via a third channel.

5. The scroll of claim 1, wherein the resonator includes an auxiliary channel fluidly extending from the chamber to the inner surface.

6. The scroll of claim 1, wherein the cylindrical body is formed by additive manufacturing.

7. A fuel injector assembly for a gas turbine engine, the fuel injector assembly comprising:
a fuel line configured to facilitate a supply of a fuel to a combustor of the gas turbine engine; and
a scroll having a cylindrical body including an axial end face and an inner surface defining a bore, a passage spanning circumferentially within the cylindrical body around the bore, an inlet channel extending from the axial end face to the passage, the inlet channel fluidly coupled to the fuel line to facilitate a flow of the fuel from the fuel line to the passage, a plurality of outlets formed in the cylindrical body to facilitate a release of the fuel from the passage for a delivery of the fuel into the combustor, the cylindrical body including:
a resonator integrally formed with the cylindrical body, the resonator including a chamber, and a channel fluidly coupling the chamber to the inlet channel.

8. The fuel injector assembly of claim 7, wherein the fuel line is a main fuel line, the fuel injector assembly including a pilot fuel line to inject a stream of pressurized fuel into the combustor.

9. The fuel injector assembly of claim 7, wherein the scroll includes a plurality of vanes extending radially inwardly into the bore from the inner surface of the cylindrical body, each vane including a cavity fluidly coupled to the passage by one or more of the plurality of outlets, wherein each vane includes one or more openings to release the fuel from the cavity.

10. The fuel injector assembly of claim 9, wherein each vane of the plurality of vanes extends from the inner surface into the bore to define an end, the scroll further including a hollow cylindrical member supported by the end of each vane.

11. The fuel injector assembly of claim 7, wherein the resonator is a first resonator and the channel is a first channel, the scroll including a second resonator with a second channel, the second channel being fluidly coupled to the inlet channel independent of a coupling of the first channel to the inlet channel.

12. The fuel injector assembly of claim 7, wherein the resonator is a first resonator and the chamber is a first chamber, the scroll including a second resonator with a second chamber, the first chamber being fluidly coupled to the second chamber via a third channel.

13. The fuel injector assembly of claim 7, wherein the resonator includes an auxiliary channel fluidly extending from the chamber to the inner surface.

14. The fuel injector assembly of claim 7, wherein the cylindrical body is formed by additive manufacturing.

15. A gas turbine engine, comprising:
a combustor;
a fuel line configured to facilitate a supply of a fuel to the combustor, and
a scroll having a cylindrical body including an axial end face and an inner surface defining a bore, a passage spanning circumferentially within the cylindrical body around the bore, an inlet channel extending from the axial end face to the passage, the inlet channel fluidly coupled to the fuel line to facilitate a flow of the fuel from the fuel line to the passage, a plurality of outlets formed in the cylindrical body to facilitate a release of the fuel from the passage for a delivery of the fuel into the combustor, the cylindrical body including:
a resonator integrally formed with the cylindrical body, the resonator including a chamber, and a channel fluidly coupling the chamber to the inlet channel.

16. The gas turbine engine of claim 15, wherein the fuel line is a main fuel line, the gas turbine engine including a pilot fuel line to inject a stream of pressurized fuel into the combustor.

17. The gas turbine engine of claim 15, wherein the scroll includes a plurality of vanes extending radially inwardly into the bore from the inner surface of the cylindrical body, each vane including a cavity fluidly coupled to the passage by one or more of the plurality of outlets, wherein each vane includes one or more openings to release the fuel from the cavity.

18. The gas turbine engine of claim 15, wherein the resonator is a first resonator and the channel is a first channel, the scroll including a second resonator with a second channel, the second channel being fluidly coupled to the inlet channel independent of a coupling of the first channel to the inlet channel.

19. The gas turbine engine of claim 15, wherein the resonator is a first resonator and the chamber is a first chamber, the scroll including a second resonator with a second chamber, the first chamber being fluidly coupled to the second chamber via a third channel.

20. The gas turbine engine of claim 15, wherein the resonator includes an auxiliary channel fluidly extending from the chamber to the inner surface.
